(19) United States
(12) Patent Application Publication
(10) Pub. No.: US 2018/0356176 A1
(43) Pub. Date: Dec. 13, 2018

(54) Process For Forming Pre-Cut Model Specific Gun Wraps

(71) Applicants: Ernest James Rose, III, North Las Vegas, NV (US); Kim Johnson, North Las Vegas, NV (US)

(72) Inventors: Ernest James Rose, III, North Las Vegas, NV (US); Kim Johnson, North Las Vegas, NV (US)

(73) Assignee: 5150Vegas LLC, North Las Vegas, NV (US)

(21) Appl. No.: 15/619,200

(22) Filed: Jun. 9, 2017

(51) Int. Cl. F41A 35/02; F41H 3/02; B44C 1/165

(52) U.S. Cl. CPC F41A 35/02; B44C 1/165; F41H 3/02

(57) ABSTRACT

The herein disclosed processes provide a methodology for forming pre-cut gun wraps that may be formed specifically for a particular make and model of firearm or firearm accessory, and may be packaged and shipped to customer in a pre-cut form that allows for easy and adjustable non-permanent application to a firearm or firearm accessory. An exemplary embodiment of the herein disclosed processes includes the steps of: drawings a digital outline of a specific make and model of firearm; measuring a gun wrap surface area; translating the gun wrap surface area into a vector template; combining the vector template with digital artwork to determine a cut path; printing on an adhesive with the digital artwork; laminating the adhesive; cutting the pre-cut model specific gun wrap from the adhesive on a plotter/cutting machine using the cut path; and removing excess material from the pre-cut model specific gun wrap. The adhesive may be a pressure sensitive adhesive vinyl material.

### BRIEF DESCRIPTION OF THE INVENTION

The present invention relates to protective and decorative coverings for firearms and firearm accessories, and more particularly, to processes for forming pre-cut make and model specific gun wraps for protecting and personalizing firearms and firearm accessories. The herein disclosed processes provide a methodology for forming pre-cut gun wraps that may be formed specifically for a particular make and model of firearm or firearm accessory, and may be packaged and shipped to customer in a pre-cut form that allows for easy and adjustable non-permanent application to a firearm or firearm accessory.

An exemplary embodiment of the herein disclosed processes includes the steps of: drawings a digital outline of a specific make and model of firearm; measuring a gun wrap surface area; translating the gun wrap surface area into a vector template; combining the vector template with digital artwork to determine a cut path; printing on an adhesive with the digital artwork; laminating the adhesive; cutting the pre-cut model specific gun wrap from the adhesive on a plotter/cutting machine using the cut path; and removing excess material from the pre-cut model specific gun wrap.

### CROSS-REFERENCES TO RELATED APPLICATIONS

Not applicable.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK

Not applicable.

### BACKGROUND OF THE INVENTION

Firearms and firearm accessories are subject to wear damage due to normal use exposing the finish of the firearm or firearm accessory to human skin oils and weather elements. This surface finish wear diminishes resale value and can be costly to restore.

Firearms and firearm accessories are manufactured in a limited variety of color and/or style selections. The ability of a firearm owner to personalize his or her firearm is thus severely limited.

Protective and decorative coverings for firearms and firearm accessories are known. For example, U.S. Pat. No. 9,581,404 to Lyon discloses pre-cut protective coverings for placement on various rifle components for providing protection against wear and tear to the firearm. But Lyon does not disclose model-specific pre-cut protective coverings, because the Lyon protective coverings as disclosed are only designed for a particular type of firearm, a rifle. And Lyon does not disclose a process for forming the protective coverings, and so there is no methodology suggested in the Lyon disclosure for forming model specific protective coverings. U.S. Pat. No. 5,101,589 to Duncan discloses functional decals which may be utilized to mark a firearm with illuminating decals so that a user of the firearm can identify a front and a back of the firearm in the absence of enough light for the user to see unaided. But as with Lyon, Duncan does not disclose a process for forming the decals and so there is no methodology suggested for forming model specific illuminating decals. U.S. Pat. No. 9,395,153 to Bottrell discloses decorative personalization in a firearm magazine holder which may be formed in colors or patterns to personalize the magazine holder. But Bottrell deals with personalization of the magazine holder itself, as opposed to decorative coverings for the magazine holder, and fails to disclose a methodology for forming model specific decorative elements. There is a need, therefore, for forming decorative and protective coverings for firearms and firearms accessories that are make and model specific so that firearm owners may protect and personalize their specific firearm.

The present invention addresses this need by providing a process for forming pre-cut model specific gun wraps that may be quickly and non-permanently applied to a firearm or firearm accessory.

### BRIEF DESCRIPTION OF THE SEVERAL VIEWS OF THE DRAWING

FIG. 1 is a schematic flowchart of a process for forming a pre-cut model specific gun wrap, in accordance with an exemplary embodiment of the present invention;

FIG. 2 illustrates a specific make and model of firearm and a digital outline of the specific make and model of firearm, in accordance with an exemplary embodiment of the present invention;

FIG. 3 illustrates a vector template combined with digital artwork, in accordance with an exemplary embodiment of the present invention;

FIG. 4A illustrates a pre-cut model specific gun wrap, in accordance with an exemplary embodiment of the present invention; and

FIG. 4B illustrates a specific make and model of firearm with the pre-cut model specific gun wrap applied thereon so as to protect and personalize the firearm.

### DETAILED DESCRIPTION OF THE INVENTION

The present invention relates to protective and decorative coverings for firearms and firearm accessories, and more particularly, to processes for forming pre-cut make and model specific gun wraps for protecting and personalizing firearms and firearm accessories. The herein disclosed processes provide a methodology for forming pre-cut gun wraps that may be formed specifically for a particular make and model of firearm or firearm accessory, and may be packaged and shipped to customer in a pre-cut form that allows for easy and adjustable non-permanent application to a firearm or firearm accessory

An exemplary embodiment of the herein disclosed processes for forming pre-cut make and model specific gun wraps includes the steps of: drawings a digital outline of a specific make and model of firearm; measuring a gun wrap surface area; translating the gun wrap surface area into a vector template; combining the vector template with digital artwork to determine a cut path; printing on an adhesive with the digital artwork; laminating the adhesive; cutting the pre-cut model specific gun wrap from the adhesive on a plotter/cutting machine using the cut path; and removing excess material from the pre-cut model specific gun wrap.

The phrase gun wrap is intended to include any protective covering for a firearm or a firearm accessory that may be applied to the outer surface(s) of the firearm or firearm accessory by an owner of the firearm or firearm accessory. Gun wraps may be non-permanently attached to the surface of the firearm or firearm accessory. Gun wraps may, in an exemplary embodiment, be formed on a pressure sensitive adhesive vinyl material. But those skilled in the art will recognize that the gun wraps disclosed herein, and the process for forming a pre-cut model specific gun wrap disclosed herein, may utilize alternative materials to form the gun wraps and all such alternative materials are intended to be included herein.

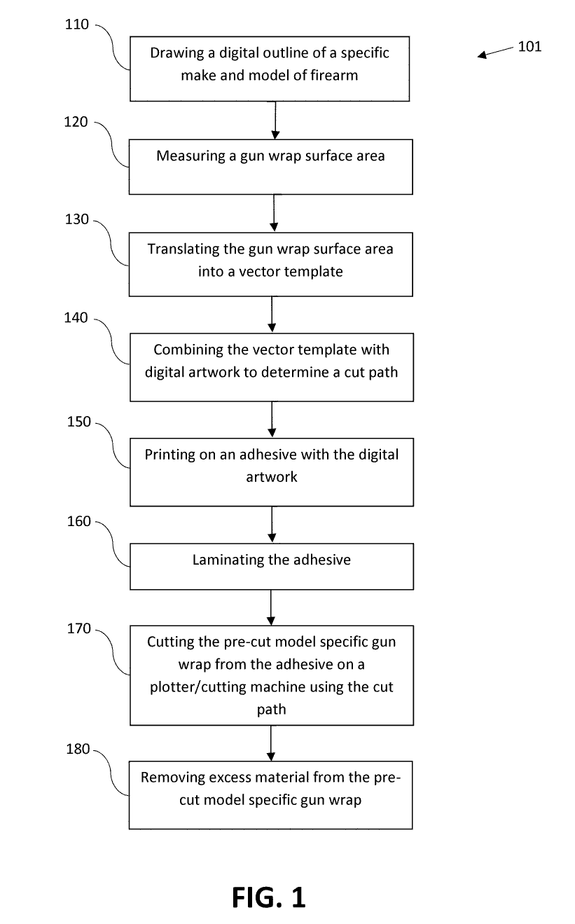

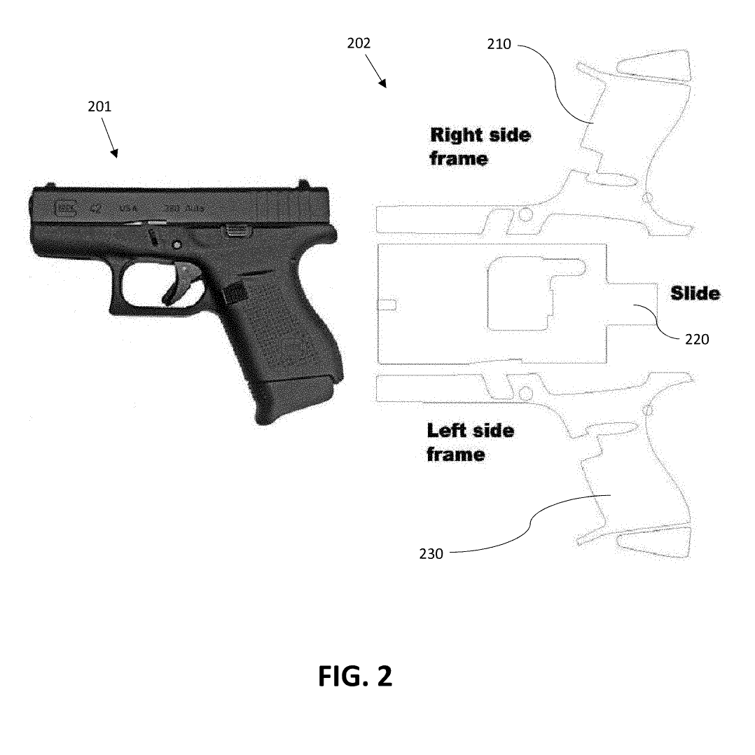

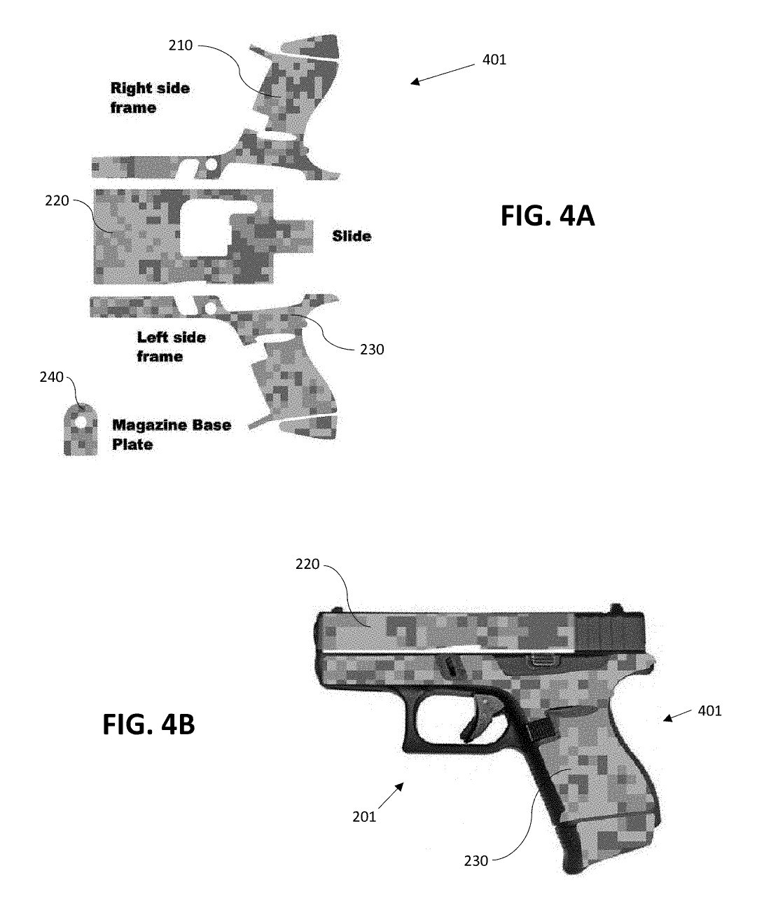

Referring to FIG. 1, the herein disclosed process 101 for forming a pre-cut model specific gun wrap includes step 110 drawing a digital outline of a specific make and model of firearm. The digital outline is a line drawing of the various components and/or surfaces of the firearm, and is drawn for a specific make and model of firearm or firearm accessory. An exemplary digital outline 202 is illustrated in FIG. 2. As seen in FIG. 2, a specific model of firearm 201 may be draw as digital outline 202. Digital outline 202 may include various surfaces and/or components of the specific make and model firearm 201, including right side frame 210, slide 220, and left side frame 230. At the end of the herein disclosed process, as seen in FIG. 4B, the various surfaces and/or components of the firearm will correspond to components of the pre-cut model specific gun wrap 401.

The herein disclosed process 101 for forming a pre-cut model specific gun wrap further includes step 120 measuring a gun wrap surface area. Such measurements may be calculated by a software application, as is known in the art. Process 101 further includes step 130 translating the gun wrap surface area, as measured in step 120, into a vector template. The vector template may be a digital vector template, as is known in the art. Step 130 may further include, in certain embodiments, the additional step of adjusting the vector template to create a proper fit vector template. In this embodiment, the proper fit vector template would then be utilized in place of the vector template for the steps subsequent to step 130.

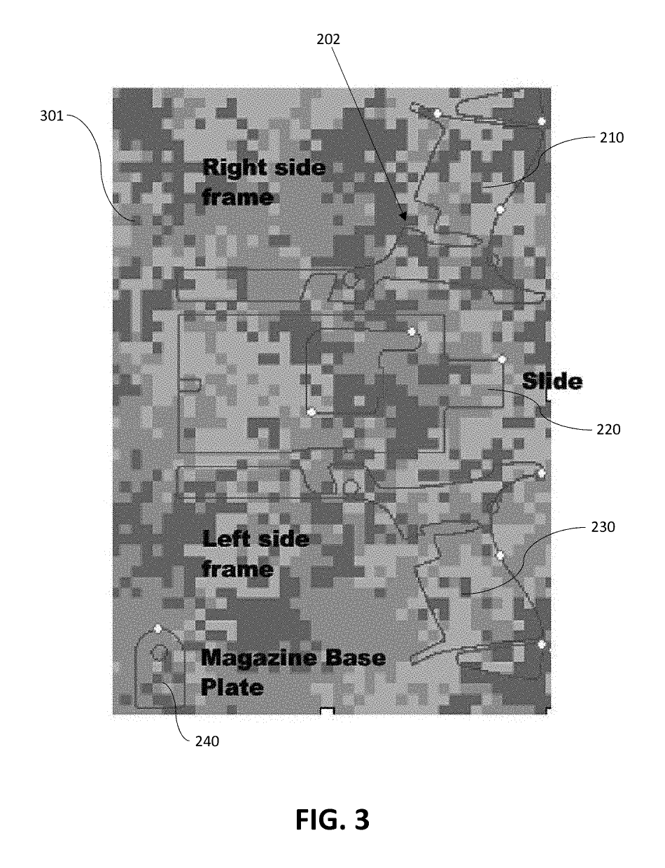

Process 101 for forming a pre-cut model specific gun wrap further includes step 140 combining the vector template with digital artwork to determine a cut path. FIG. 3 illustrates a vector template combined with digital artwork, in accordance with the herein disclosed process. Digital artwork can include any picture, pattern, color or combination thereof. The digital artwork can be selected from a database of stock digital artwork, or alternatively, a customer can provide customer digital artwork for use on pre-cut model specific gun wraps. In such an embodiment, step 140 combining the vector template with digital artwork may further include the step of receiving a customer digital artwork from a customer and utilizing the customer digital artwork as the digital artwork in subsequent steps. A software application may be utilized to determine a cut path from the combination of the vector template and the digital artwork, as is known in the art. The cut path, after determination in step 140, may be saved and stored as computer readable code or as a computer readable file, as is known in the art, so that it may be utilized by a plotter/cutting machine communicatively connected to the software application determining the cut path.

Process 101 for forming a pre-cut model specific gun wrap further includes step 150 printing on an adhesive with the digital artwork. This step of printing an adhesive with the digital artwork may, in certain embodiments, utilize the gun wrap surface area to determine a print area for the adhesive. The adhesive utilized in step 150 may be any adhesive known in the art that provides a surface receptive to the printed digital artwork while also providing sufficient adhesiveness to allow for application of the pre-cut model specific gun wraps to the firearm (or firearm accessory) in a secure but non-permanent fashion. In an exemplary embodiment, the adhesive is a pressure sensitive adhesive vinyl. After step 150, process 101 then includes step 160 laminating the adhesive. The step of laminating the adhesive may involve, in certain embodiments, laminating the adhesive with a clear protective layer of material, which may be a pressure sensitive adhesive vinyl.

Process 101 for forming a pre-cut model specific gun wrap further includes step 170 cutting the pre-cut model specific gun wrap from the adhesive on a plotter/cutting machine using the cut path. After laminating the printed digital artwork (on the adhesive), the vector template is communicated to a plotter/cutting machine and the plotter/cutting machine uses the vector template to cut the various components necessary for the pre-cut model specific gun wrap into the adhesive. The vector template may be communicated by any method of file (or code) transfer known in the art; for example, the internet may be utilized to electronically transfer the vector template to the plotter/cutting machine. The plotter/cutting machine may be any device known in the art that may be utilized to precisely cut the adhesive along a previously determined cut path.

Finally, process 101 for forming a pre-cut model specific gun wrap further includes step 180 removing excess material from the pre-cut model specific gun wrap. After the plotter/cutting machine has cut along the cut path, any excess adhesive material not necessary for the gun wrap (in other words, the material outside the lines of the vector template) is removed, leaving behind only the precisely cut pre-cut model specific gun wrap. FIG. 4A illustrates a final product of the herein disclosed process 101 for forming a pre-cut model specific gun wrap. Pre-cut model specific gun wrap 401 may include various components corresponding to the various surfaces/components of the specific model of firearm 201. For example, pre-cut model specific gun wrap 401 may include a right side frame decal, a slide decal, a left side frame decal, and a magazine base plate decal, as seen in FIG. 4A.

After completion of the herein disclosed process, the pre-cut model specific gun wrap may be packaged and shipped (or sold) to a customer. The customer will receive a gun wrap that is specifically designed for his or her firearm (the particular make and model), and that is already pre-cut so that the individual components (the ride side frame decal, the slide decal, the left side frame decal, and the magazine base plate decal, for example) are ready to be applied to the firearm by the customer. FIG. 4B shows a firearm with several components of the gun wrap applied; visible in FIG. 4B are the slide decal applied to slide 220 and the left side frame decal applied to left side frame 230.

Throughout this specification, the present invention processes are mostly described in terms of a specific make and model of firearm. Wherever the term firearm appears, it is intended to include both firearms and firearm accessories.

While the present invention has been illustrated and described herein in terms of a preferred embodiment and several alternatives, it is to be understood that the systems and methods described herein can have a multitude of additional uses and applications. Accordingly, the invention should not be limited to just the particular description and various drawing figures contained in this specification that merely illustrate a preferred embodiment and application of the principles of the invention.

What is claimed is:

1. A process for forming a pre-cut model specific gun wrap, comprising the steps of:
drawing a digital outline of a specific make and model of firearm;
measuring a gun wrap surface area;
translating the gun wrap surface area into a vector template;
combining the vector template with digital artwork to determine a cut path;
printing on an adhesive with the digital artwork;
laminating the adhesive;
cutting the pre-cut model specific gun wrap from the adhesive on a plotter/cutting machine using the cut path; and
removing excess material from the pre-cut model specific gun wrap.

2. The process for forming a pre-cut model specific gun wrap as recited in claim 1, wherein the pre-cut model specific gun wrap includes a right side frame decal, a slide decal, a left side frame decal, and a magazine base plate decal, and wherein the digital outline of a specific make and model of firearm includes a ride side frame, a slide, a left side frame, and a magazine base plate.

3. The process for forming a pre-cut model specific gun wrap as recited in claim 1, wherein the step of combining the vector template with digital artwork includes the step of receiving a customer digital artwork from a customer and utilizing the customer digital artwork as the digital artwork.

4. The process for forming a pre-cut model specific gun wrap as recited in claim 1, wherein the adhesive is a pressure sensitive adhesive vinyl.
